(19) United States
(12) Patent Application Publication
(10) Pub. No.: US 2016/0334956 A1
(43) Pub. Date: Nov. 17, 2016

(54) ELECTRONIC APPARATUS AND INFORMATION DISPLAY METHOD OF THE ELECTRONIC APPARATUS

(71) Applicant: KYOCERA CORPORATION, Kyoto-shi (JP)

(72) Inventor: Takenori TOMINO, Yokohama-shi (JP)

(73) Assignee: KYOCERA Corporation, Kyoto (JP)

(21) Appl. No.: 15/110,812

(22) PCT Filed: Jan. 13, 2015
(86) PCT No.: PCT/JP2015/000115

§ 371 Date: Jul. 11, 2016

(30) Foreign Application Priority Data
Jan. 17, 2014 (JP) 2014-007008

(51) Int. Cl. G06F 3/0484; G06F 3/0488; H04M 1/725; G06F 3/0346; H04L 12/58; G06F 3/02; G06F 3/0482

(52) U.S. Cl. CPC G06F 3/0484; G06F 3/02; G06F 3/0488; G06F 3/0482; G06F 3/0346; H04L 51/24; H04M 1/72552

(57) ABSTRACT

An electronic apparatus of the disclosure herein is an electronic apparatus 10 having a controller 11 for providing a notification of, upon reception of a mail, mail information containing a portion of contents of the mail in a display unit 12, wherein the controller 11, when a screen of the display unit 12 changes from an off-state to an on-state, provides a re-notification of the mail information of an unread mail in the display unit 12 and, based on an input operation via an input unit 13 during the re-notification, displays the mail information in the display unit 12.

### CROSS REFERENCE TO RELATED APPLICATION

This application claims priority to and the benefit of Japanese Patent Application No. 2014-007008 (filed on Jan. 17, 2014), the entire contents of which are incorporated herein by reference.

### TECHNICAL FIELD

This disclosure relates to an electronic apparatus capable of notifying of contents of an unread mail for a plurality of times and an information display method of the electronic apparatus.

### BACKGROUND

As one of functions of electronic apparatuses such as feature phones and smartphones, there is a communication function to exchange e-mail (hereinafter, appropriately abbreviated as a “mail”). The electronic apparatus, upon receiving the mail, notifies a user of reception thereof. The electronic apparatus notifies the user of the reception of the mail by, for example, generating a reception sound, vibrating a vibrator, or flashing an LED of the electronic apparatus. The electronic apparatus is known to be able to display a summary of the received mail at this time. For example, PLT 1 set forth below describes a mobile phone that displays mail information containing Pict-information® (Pict-information is a registered trademark in Japan, other countries, or both) of a sender of a received e-mail and a title (a subject) of the received e-mail.

### CITATION LIST

### Patent Literature

PLT 1: JP2011070497A

### SUMMARY

### Technical Problem

The Pict-information is displayed upon reception of the mail by the electronic apparatus. That is, the electronic apparatus, after displaying the Pict-information once, displays the number of unread mails in a display unit without displaying information on summaries (contents) of the unread mails. Therefore, when the user misses the Pict-information and wishes to view the Pict-information, the user needs to access and open the mail in an inbox. Such an electronic apparatus does not offer convenience. Further, since the Pict-information is displayed upon reception of the mail, when the user does not notice the reception of the mail, or when the user cannot use the electronic apparatus when the mail is received, the user is likely to miss the Pict-information.

In view of the above problem, it could be helpful to provide an electronic apparatus and an information display method of the electronic apparatus which are capable of improving convenience.

### Solution to Problem

In order to solve the above problem, an electronic apparatus of the disclosure herein is an electronic apparatus having a controller for providing a notification of, upon reception of a mail, mail information containing a portion of contents of the mail in a display unit, wherein

the controller, when a screen of the display unit changes from an off-state to an on-state, provides a re-notification of the mail information of an unread mail in the display unit and, based on an input operation via an input unit during the re-notification, displays the mail information in the display unit.

The input unit is constituted by using operation buttons, and the controller, based on the pressing of a predetermined button of the operation buttons, may update the mail information and display updated mail information in the display unit.

The input unit is constituted by using a touch panel disposed on a front surface of the display unit, and the controller, based on an operation to the touch panel at a position corresponding to a display position of the mail information, may update the mail information and display updated mail information in the display unit.

The input unit is constituted by using a touch panel disposed on a front surface of the display unit, and the controller, based on an operation to the touch panel at a position corresponding to a display position of the mail information, may display a list of unread mails in the display unit.

The input unit is constituted by using a touch panel disposed on a front surface of the display unit, and the controller, based on an operation to the touch panel at a position corresponding to a display position of the mail information, may display contents of the unread mail in the display unit.

An electronic apparatus of the disclosure herein is an electronic apparatus having a controller for providing a notification of, upon reception of a mail, mail information containing a portion of contents of the mail in a display unit, wherein

the controller, when a screen of the display unit changes from an off-state to an on-state, provides a re-notification of the mail information of an unread mail in the display unit and, based on an input operation via an input unit during the re-notification, refrains from providing the re-notification of the mail information after the input operation.

The controller, based on the input operation, may remove the unread mail associated with the mail information from a storage unit storing the unread mail.

An electronic apparatus of the disclosure herein is an electronic apparatus having a controller for providing a notification of, upon reception of a mail, mail information containing a portion of contents of the mail in a display unit, wherein

the controller, when a screen of the display unit changes from an off-state to an on-state, provides a re-notification of the mail information of an unread mail in the display unit and, based on a tilt of the electronic apparatus detected by a tilt detection unit during the re-notification, displays the mail information in the display unit.

Although an apparatus is used as a solution of the disclosure herein in the above description, a method virtually corresponding to the apparatus may also substantialize the disclosure herein and is included in the scope of the disclosure herein.

For example, an information display method of an electronic apparatus according to the disclosure herein is an information display method of an electronic apparatus having a controller for providing a notification of, upon reception of a mail, mail information containing a portion of contents of the mail in a display unit, the information display method includes:

providing a re-notification of, when a screen of the display unit changes from an off-state to an on-state, the mail information of an unread mail in the display unit; and

displaying, based on an input operation via an input unit during the re-notification, the mail information in the display unit.

Also, an information display method of an electronic apparatus according to the disclosure herein is an information display method of an electronic apparatus having a controller for providing a notification of, upon reception of a mail, mail information containing a portion of contents of the mail in a display unit, the information display method includes:

providing a re-notification of, when a screen of the display unit changes from an off-state to an on-state, the mail information of an unread mail in the display unit; and

refraining from, based on an input operation via an input unit during the re-notification, providing the re-notification of the mail information after the input operation.

Further, an information display method of an electronic apparatus according to the disclosure herein is an information display method of an electronic apparatus having a controller for providing a notification of, upon reception of a mail, mail information containing a portion of contents of the mail in a display unit, the information display method includes:

providing a re-notification of, when a screen of the display unit changes from an off-state to an on-state, the mail information of an unread mail in the display unit; and

displaying, based on a tilt of the electronic apparatus detected by a tilt detection unit during the re-notification, the mail information in the display unit.

### Advantageous Effect

The electronic apparatus and the information display method of the electronic apparatus of the disclosure herein configured as described above may improve convenience.

### BRIEF DESCRIPTION OF THE DRAWINGS

In the accompanying drawings:

FIG. 1 is a block diagram illustrating a schematic configuration of an electronic apparatus according to a first embodiment of the disclosure herein;

FIGS. 2A and 2B are diagrams illustrating implementing structures of the electronic apparatus according to the first embodiment;

FIG. 3 is a diagram illustrating an example of mail information displayed in a display unit of the electronic apparatus;

FIG. 4 is a diagram illustrating an example to display a plurality of mail information in the display unit of the electronic apparatus;

FIG. 5 is a diagram illustrating an example to display the mail information in a locked screen in the display unit of the electronic apparatus;

FIG. 6 is a diagram illustrating an example to display the mail information when power of the electronic apparatus is turned on;

FIGS. 7A and 7B are diagrams illustrating examples to display updated mail information;

FIGS. 8A and 8B are diagrams illustrating other examples to display updated mail information;

FIG. 9 is a diagram illustrating an example to display a list of unread mails;

FIG. 10 is a diagram illustrating an example to display contents of the unread mail;

FIG. 11 is a diagram illustrating an example to remove an unread mail; and

FIG. 12 is a block diagram illustrating a schematic configuration of an electronic apparatus according to a second embodiment of the disclosure herein.

### DETAILED DESCRIPTION

Hereinafter, embodiments of the disclosure herein will be described with reference to the accompanying drawings.

### First Embodiment

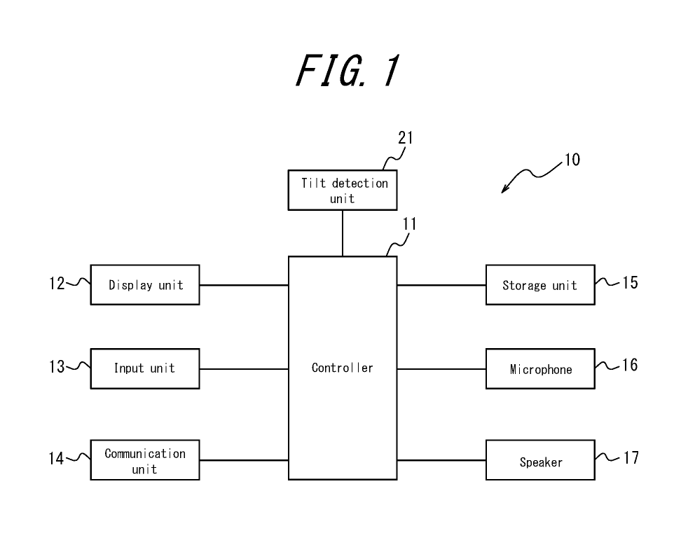

FIG. 1 is a block diagram illustrating a schematic configuration of an electronic apparatus 10 according to a first embodiment. As illustrated in FIG. 1, the electronic apparatus 10 includes a controller 11, a display unit 12, an input unit 13, a communication unit 14, a storage unit 15, a microphone 16, a speaker 17, and a tilt detection unit 21.

The controller 11 is a processor for controlling and managing the entire electronic apparatus 10 including each functional block thereof. For example, the controller 11, under predetermined conditions, notifies (informs) the user of mail information containing a portion of contents of an unread mail received by the electronic apparatus 10 via the communication unit 14, by displaying the mail information in the display unit 12. Also, for example, the controller 11, based on a user's input operation to the input unit 13, controls each functional block such that the electronic apparatus 10 operates in accordance with the user's input operation. The predetermined conditions and specific control of the controller 11 described above will be described later.

The display unit 12 is a display device such as a liquid crystal display, an organic EL display, or an inorganic EL display. The display unit 12 displays characters, photographs, and pictures such as objects for operations and the like. For example, when the electronic apparatus 10 receives a mail via the communication unit 14, the display unit 12 displays the mail information containing a sender of the mail, a title (a subject) of the mail, and the like.

The input unit 13 is configured to receive an input operation from a user and is constituted by using, for example, an operation button (an operation key). When the electronic apparatus 10 has a touch panel, the touch panel functions as the input unit 13 by detecting a contact made by a user's finger, a stylus pen, or the like and receiving the contact as the input operation.

The communication unit 14, by carrying out a radio communication with a base station or another electronic apparatus, transmits and receives data. For example, the communication unit 14 receives a mail sent by another electronic apparatus from the base station.

The storage unit 15 may be constituted by using a semiconductor memory or the like. The storage unit 15 stores various information and programs for operating the electronic apparatus 10 and also functions as a work memory.

The microphone 16 collects ambient sounds including a user's speech and the like. The sound collected by the microphone 16 is converted into an electric signal, which is then transmitted to the controller 11.

The speaker 17 outputs voice, music, and a sound such as a ringtone.

The tilt detection unit 21 detects a tilt of the electronic apparatus 10. The tilt detection unit 21 is constituted by using, for example, an acceleration sensor.

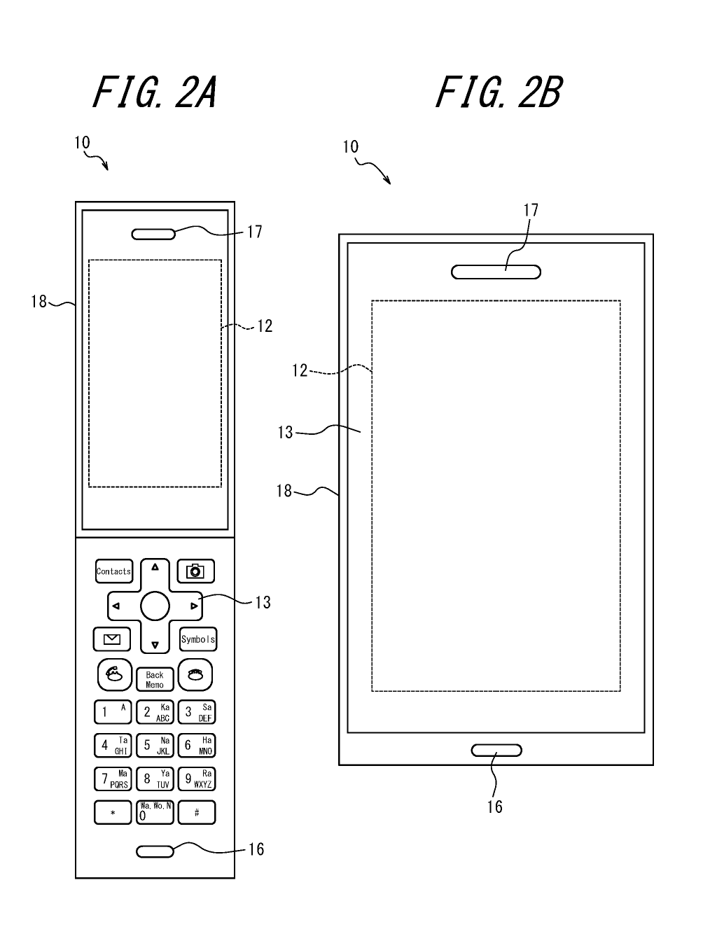

FIGS. 2A and 2B are diagrams illustrating implementing structures of the electronic apparatus 10 according to the first embodiment. FIG. 2A is an elevation view of what is called a folding-type feature phone serving as the electronic apparatus 10. A housing 18 of this electronic apparatus 10 has a display unit 12 on an upper front surface thereof and the operation button serving as the input unit 13 on a lower front surface thereof. The electronic apparatus 10, on a rear surface thereof, may have a sub-display serving as the display unit 12. The sub-display, in a state where the feature phone is folded, displays, for example, time, the mail information, and the like. Although FIG. 2A illustrates the folding-type feature phone, the feature phone is not limited to the folding type but may be of what is called a straight type or a slide type.

FIG. 2B is an elevation view of what is called a smartphone serving as the electronic apparatus 10. A housing 18 of this electronic apparatus 10 has a display unit 12 approximately at the center of a front surface thereof. To allow a user's operation, the input unit 13 constituted by using the touch panel is disposed on the front surface of the display unit 12.

Next, the display of the display unit 12 of the electronic apparatus 10 according to an embodiment will be described. The electronic apparatus 10, upon reception of a mail via the communication unit 14, displays the mail information in the display unit 12, thereby notifying the user of the mail information. The mail information contains a portion of the contents of the mail such as, for example, the sender of the mail, the title (the subject) of the mail, and information extracted from a body of the mail. In an embodiment, hereinafter, the mail information is assumed to contain the sender and the title of the mail. However, the mail information may contain a predetermined number of characters at the beginning of the body of the mail.

For example, when the electronic apparatus 10, from a sender who is registered in the mane of “AA BB” with the storage unit 15, receives a mail titled (with a subject) “Regarding start time of meeting tomorrow”, the controller 11 of the electronic apparatus 10 provides a mail information display unit 19 for displaying the mail information in a portion of the display unit 12 and controls the mail information display unit 19 to display the mail information containing the sender and the title. When the sender of the mail is not registered with the storage unit 15, the controller 11 may display an e-mail address of the sender in the mail information display unit 19.

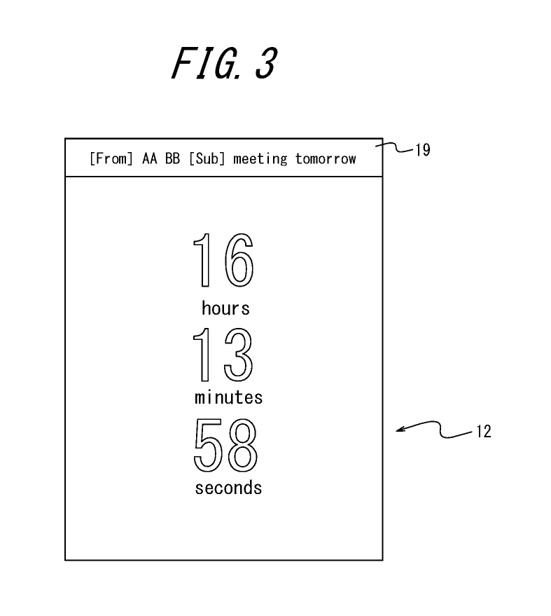

FIG. 3 is a diagram illustrating an example of the mail information displayed in the display unit 12 of the electronic apparatus 10. As illustrated in FIG. 3, the mail information is displayed in the mail information display unit 19 occupying a predetermined area of the display unit 12. Although in FIG. 3 the mail information display unit 19 is positioned at an upper end of the display unit 12, the position of the mail information display unit 19 is not limited thereto but may be at a center of, or a lower end of, the display unit 12. Also, the mail information display unit 19 may be located at a right end or left end of the display unit 12 to display the mail information in a vertical line. When the electronic apparatus 10 is the folding-type feature phone with the sub-display serving as the display unit 12, the mail information display unit 19 may be located in the sub-display. Also, when the entire mail information does not fit in the mail information display unit 19, the controller 11 may scroll the mail information displayed in the mail information display unit 19.

A conventional electronic apparatus, upon reception of the mail as described above, displays the mail information in the display unit 12 and then displays the number of unread mails. However, since the mail information once displayed is not displayed again, the user wishing to view the mail information needs to open the mail in an inbox. On the other hand, the electronic apparatus 10 of the disclosure herein, when a screen of the display unit 12 changes from an off-state to an on-state, may notify the user of the mail information of an unread mail once again. The following is a description of a method to display the mail information once again by using the electronic apparatus 10 of the disclosure herein.

The controller 11 of the electronic apparatus 10, when the screen of the display unit 12 is changed from the off-state to the on-state, may display the mail information in the display unit 12. When the screen is in the off-state, light of the display unit 12 is off. Therefore, when the screen is in the off-state, the power of the electronic apparatus 10 is off, for example. Also, in the off-state of the screen the display of the display unit 12 is turned off and a power-saving screen is displayed, because the user performs a predetermined operation to the electronic apparatus 10, or because no operation is performed to the electronic apparatus 10 for a predetermined period of time (for example, 10 seconds). In a case where the electronic apparatus 10 is the folding-type feature phone, when the feature phone being open is folded, the screen is turned off. Also, when the screen is on, it means that the display unit 12 displays the screen in response to the predetermined operation to the electronic apparatus 10 performed by the user. For example, when the user turns on the power of the electronic apparatus 10, the screen is turned on. Also, for example, when the folding-type feature phone being folded is opened, the screen of the display unit 12 is turned on and the mail information is displayed in the display unit 12 of the electronic apparatus 10 as illustrated in FIG. 3. In this way, since the user is notified of the mail information nonce again, the user, without necessity to open the mail in the inbox, may easily view the mail information simply by turning on the screen of the electronic apparatus 10. Accordingly, convenience of the electronic apparatus 10 is improved.

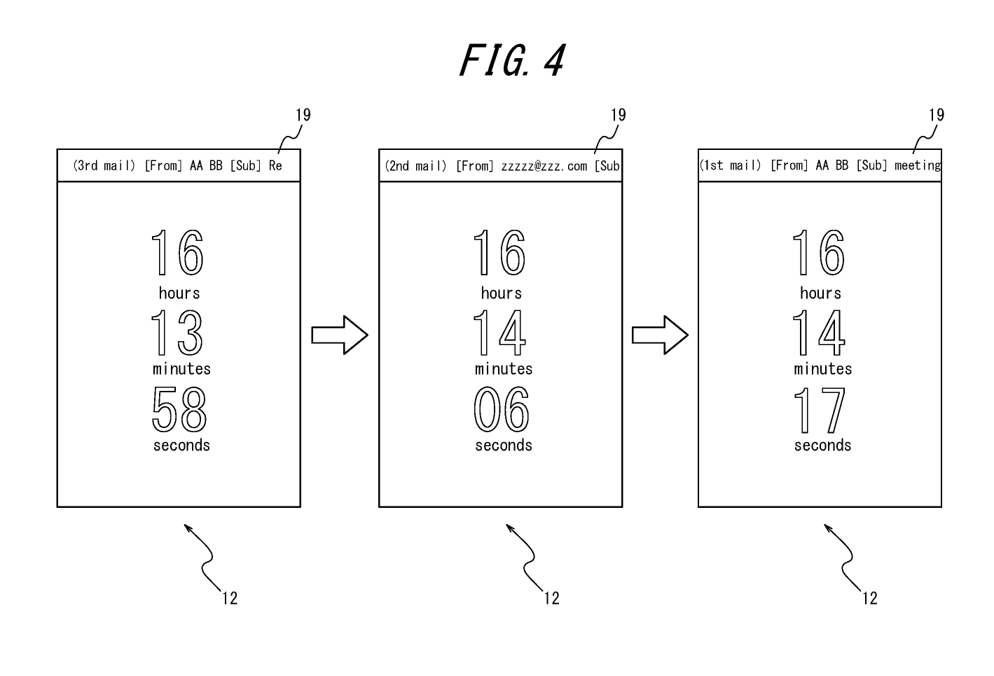

Here, when there are a plurality of mail information to notify once again, the controller 11 may sequentially display the plurality of mail information in, for example, chronological order or in reverse chronological order of reception date and time of the mails by scrolling the plurality of mail information in the mail information display unit 19 in the display unit 12. FIG. 4 is a diagram illustrating an example to display a plurality of mail information in the display unit 12 of the electronic apparatus 10. For example, when the storage unit 15 of the electronic apparatus 10 stores three unread mails, the controller 11, as illustrated in FIG. 4, sequentially displays the mail information of the three unread mails in the mail information display unit 19 by scrolling the mail information. At this time, the mail information may include, for example, the reception date and time of each mail. In this way, the user may easily view a plurality of mail information, and thus the convenience of the electronic apparatus 10 is improved. Hereinafter, it is assumed that the controller 11, when displaying a plurality of mail information in the mail information display unit 19, sequentially displays the mail information from the mail information of a mail with the latest reception date and time.

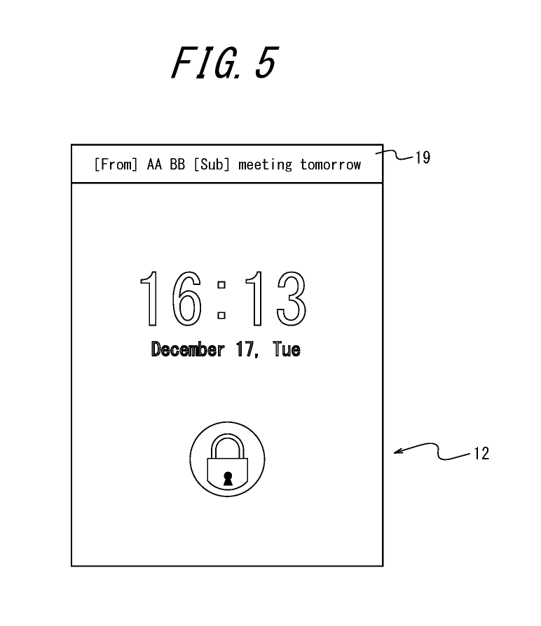

In a case where the electronic apparatus 10 is the smartphone, especially when the screen is turned on in response to the predetermined operation to the electronic apparatus 10 performed by the user, the display unit 12 typically displays a locked screen. In this case, the controller 11 may notify the user of the mail information by displaying the mail information in the locked screen displayed in the display unit 12. FIG. 5 is a diagram illustrating an example to display the mail information in the locked screen displayed in the display unit 12. In this way, since the mail information is displayed in the locked screen, the user may easily view the mail information without necessity to unlock, and thus the convenience of the electronic apparatus 10 is improved. Note that, since the locked screen is provided in the interest of secure protection of information stored in the electronic apparatus 10, the mail information displayed in the locked screen may contain only limited information as compared with the mail information displayed after unlocking.

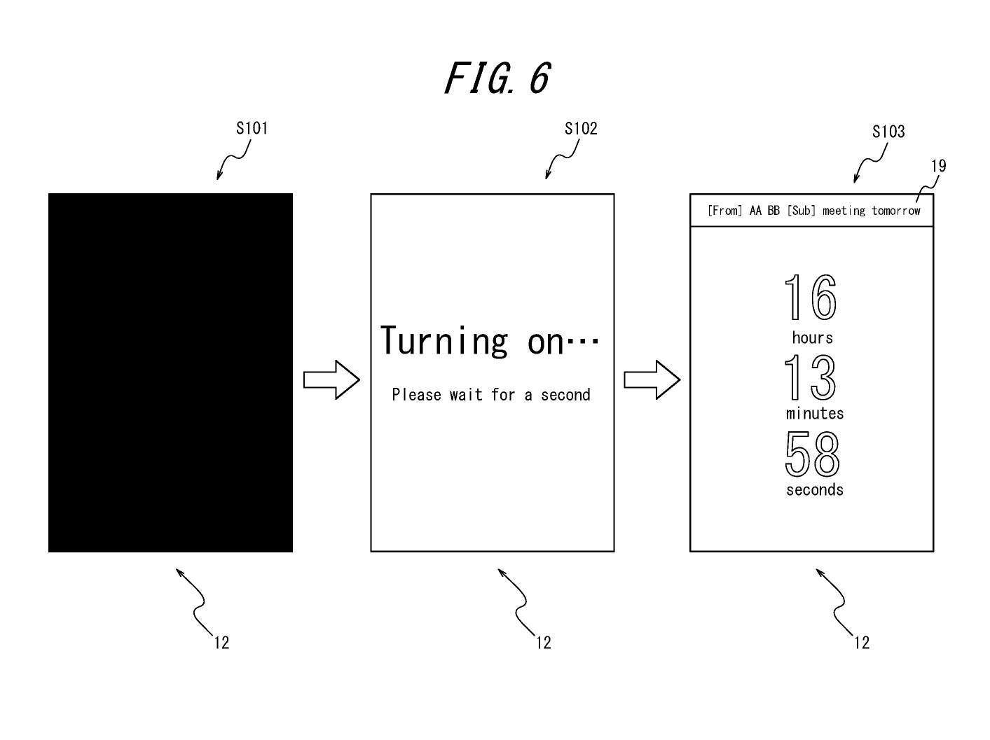

Further, the controller 11 of the electronic apparatus 10, when the power of the electronic apparatus 10 is turned on, may control the display unit 12 to display the mail information. FIG. 6 is a diagram illustrating an example to display the mail information when the power of the electronic apparatus 10 is turned on. As illustrated in FIG. 6, when the power of the electronic apparatus 10 is off, the display unit 12 is off (step S101). Then, when the electronic apparatus 10 is turned on in response to a user's operation, the display unit 12 displays a screen indicating that the electronic apparatus 10 is being turned on (step S102). When the power of the electronic apparatus 10 is completely turned on, the mail information is displayed in the mail information display unit 19 (step S103). In this way, since the user is notified of the mail information once again, the user may view the mail information by simply turning on the power of the electronic apparatus 10. Especially when the user moves away from a place such as a movie theater and a play theater where the power of the electronic apparatus 10 needs to be turned off, the user may quickly view the mail information by turning on the power of the electronic apparatus 10, and thus the convenience of the electronic apparatus 10 is improved.

Especially when the electronic apparatus 10 is the smartphone and displays the mail information when the power of the electronic apparatus 10 is turned on, the locked screen is normally displayed in the display unit 12 when the power is turned on. In this case, the controller 11 may notify the user of the mail information once again by displaying the mail information in the locked screen as illustrated in FIG. 5 at step S103 in FIG. 6.

Next, the display of the mail information when the user performs an input operation by using the input unit 13 while the controller 11 is displaying the mail information once again in the mail information display unit 19 will be described.

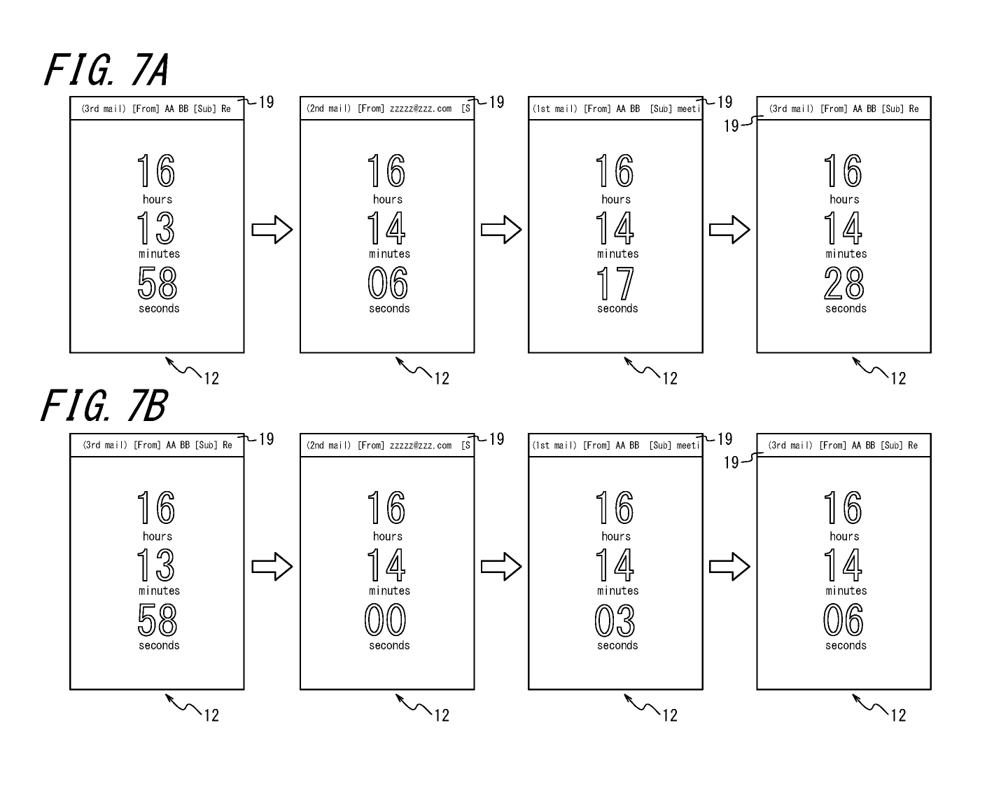

First, an operation to update the display of the mail information will be described. FIGS. 7A and 7B are diagrams illustrating examples to update and display the mail information in response to the user's input to the input unit 13. Here, it is assumed that the electronic apparatus 10 is the feature phone and the input unit 13 is the operation key. However, the electronic apparatus 10 and the input unit 13 are not limited thereto. Also, although it is assumed here that the storage unit 15 stores three unread mails and the controller 11 controls to display the mail information of the three unread mails, the number of unread mails and display time of the mail information are not limited to those described below but may vary appropriately.

The controller 11 sequentially displays the mail information from the mail information of the third mail, i.e., the latest unread mail in the mail information display unit 19 in the display unit 12. When the user does not operate the input unit 13 while the mail information is displayed, since the mail information is scrolled and sequentially displayed as illustrated in FIG. 7A, it takes time for all of the mail information to be scroll and displayed. Although in FIG. 7A the controller 11, after all of the mail information is displayed, displays the mail information once again from the beginning, i.e., from the mail information of the third mail, the display of the display unit 12 after displaying all of the mail information is not limited thereto. For example, the controller 11, after displaying all of the mail information, may control the mail information display unit 19 in the display unit 12 to display a remaining battery level of the electronic apparatus 10, a reception strength of the radio wave for a communication by the communication unit 14, the presence/absence of an unread mail, and the like. Also, for example, the controller 11, after displaying all of the mail information, may control the mail information display unit 19 in the display unit 12 to display an indication that all of the mail information has been displayed.

Here, when the user presses a predetermined operation button for updating the display of the mail information while the controller 11 is displaying the mail information of the third mail in the mail information display unit 19, the controller 11 updates the display of the mail information display unit 19. The display may be updated as desired. For example, the controller 11, as illustrated in FIG. 7B, may update and display the mail information (here, the mail information of the second mail) next to the mail information being displayed when the operation button is pressed. Such update of the display may be performed continuously. For example, as illustrated in FIG. 7B, the user may skip the mail information of the second mail and display the mail information of the first mail by pressing the same operation button while the mail information of the second mail is displayed in the mail information display unit 19. When the user presses the same operation button while the mail information of the first mail, i.e., the mail information of the last mail is displayed, the controller 11 may display the mail information from the beginning as illustrated in FIG. 7B or display the indication that all of the mail information has been displayed. When the operation button is pressed while the mail information of the first mail is displayed, the controller 11 does not need to update the display at all. In this way, the user, by updating the display and skipping some mail information, may quickly display desired mail information in the mail information display unit 19.

Note that, although in the above description the display is updated to skip the mail information, the update of the display is not limited thereto. For example, the controller 11, when the predetermined operation button is pressed, may once again display the mail information from the beginning. In this case, the update of the display allows the user to view the mail information from the beginning even in the middle of the display of the mail information. Also, for example, the controller 11, when the predetermined operation button is pressed, may update the display such that the mail information being displayed in the mail information display unit 19 when the predetermined operation button is pressed is displayed once again. In this case, the update of the display allows the user to once again view the mail information that is being viewed.

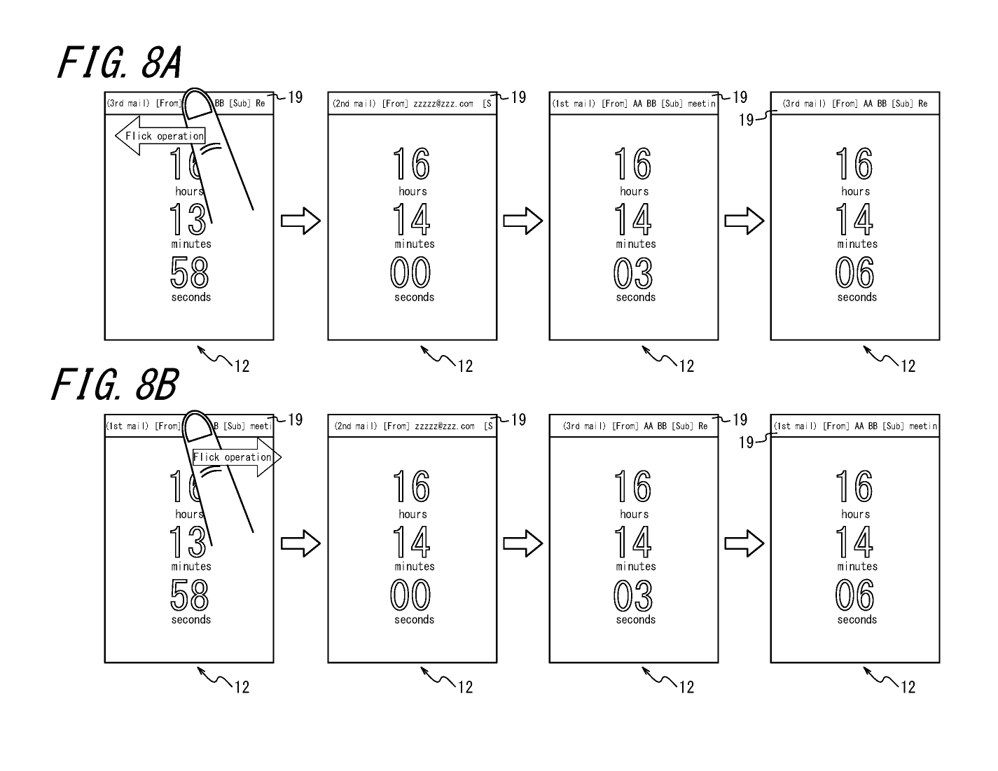

Next, an operation to skip the display of the mail information by using the smartphone will be described. FIGS. 8A and 8B are diagrams illustrating other examples to update and display the mail information in response to a user's input to the input unit 13. Here, the electronic apparatus 10 is the smartphone, and the input unit 13 is the touch panel disposed on the front surface of the display unit 12. Here, similarly to the description with reference to FIGS. 7A and 7B, it is assumed that three unread mails are stored in the storage unit 15 and the controller 11 displays the mail information of the three mails.

Similarly to FIG. 7A, the controller 11 sequentially displays the mail information from the mail information of the third mail, i.e., the mail information of the latest unread mail, in the mail information display unit 19 in the display unit 12. Here, as illustrated in FIG. 8A, when the user flicks to the left at a display position of the mail information, i.e., a portion of the touch panel corresponding to the mail information display unit 19 while the mail information of the third mail is displayed, the controller 11 detects such a flick operation and updates the display of the mail information display unit 19. Here, since the user flicks to the left in the mail information display unit 19, the controller 11 updates the display and displays the mail information next to the mail information of the third mail being displayed in the mail information display unit 19, i.e., the mail information of the second mail. Here, the flick operation is a user's operation to touch the touch panel with the finger, move (slide) the finger in one direction without releasing the finger from the touch panel, and then release the finger from the touch panel. The user may perform the flick operation in a similar manner while the mail information of the second mail is displayed. That is, when the user flicks to the left while the mail information of the second mail is displayed in the mail information display unit 19, the controller 11 updates the display and displays the mail information of the first mail in the mail information display unit 19. When the user flicks to the left while the mail information of the first mail is displayed, the controller 11 may once again display the mail information from the beginning as illustrated in FIG. 8A or the indication that all of the mail information has been displayed. Alternatively, when the user flicks in a similar manner while the mail information of the first mail is displayed, the controller 11 does not need to update the display at all.

The direction of the flick operation is not limited to the left but may be the right as well. FIG. 8B is a diagram illustrating an example to display the mail information when the user flicks to the right. When the user flicks to the right, the display is updated and the mail information is displayed in a reverse order of the scrolling in response to the flick operation to the left. For example, as illustrated in FIG. 8B, when the user flicks to the right at a portion of the touch panel corresponding to the mail information display unit 19 while the mail information of the first mail is displayed in the mail information display unit 19, the controller 11 displays previous mail information of the mail information of the first mail, i.e., the mail information of the second mail. When the user flicks to the right once again, the controller 11 displays the mail information of the third mail. When the user flicks while the mail information of the latest mail (here, the mail information of the third mail), the controller 11 may display the mail information of the first mail as illustrated in FIG. 8B or the indication that all of the mail information has been displayed. Alternatively when the user flicks to the right while the mail information of the latest mail is displayed, the controller 11 does not need to update the display at all. In this way, the user may quickly display desired mail information by updating the display and skipping some mail information.

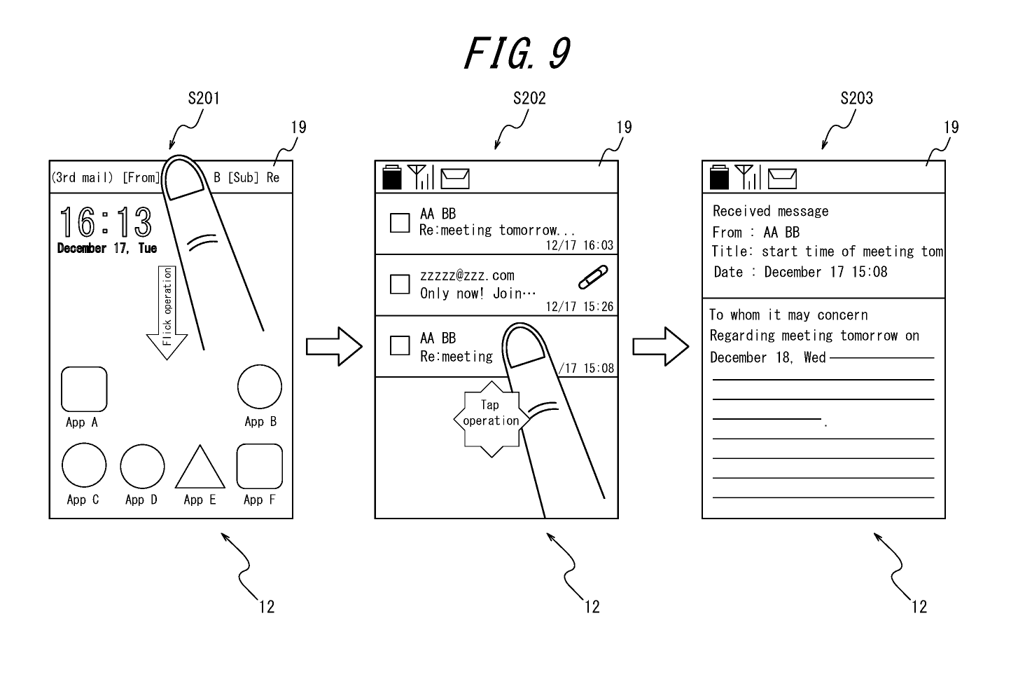

Next, an operation of the mail information display unit 19 to display the list of the unread mails will be described. FIG. 9 is a diagram illustrating an example to display the list of the unread mails by using the electronic apparatus 10. It is assumed here that the electronic apparatus 10 is the smartphone and the input unit 13 is the touch panel disposed on the front surface of the display unit 12, as well as that three unread mails are stored in the storage unit 15.

The controller 11 sequentially displays the mail information of the three mails in the mail information display unit 19. As illustrated in FIG. 9, when the user flicks downward at a portion of the touch panel corresponding to the mail information display unit 19 while the mail information is once again displayed in the display unit 12 (step S201), the controller 11, based on the user's input operation via the input unit 13, displays the list of the unread mails in the display unit 12 (step S202). By view the display in the display unit 12, the user may know the number of unread mails and portions of contents of the unread mails. The contents of the mails displayed in the list of the unread mails may be determined as desired; as illustrated in FIG. 9, for example, the contents may be the sender, the title of the mail, the reception date and time of the mail, the presence/absence of an attached file, and the like. Also, the contents of the mail displayed in the list of the unread mails may include a predetermined number of characters at the beginning of the body of the mail. The user may select the mail to view from the list of the unread mail by tapping, thereby displaying the contents of the selected mail to view in the display unit 12 (step S203). Here, such a tapping operation is a user's operation to touch the touch panel with the finger and then release the finger from the touch panel. Thereby, the user may easily view the list of the unread mail. Also, such a tapping operation allows the user to quickly access the unread mail the user desires and view the contents thereof. Note that, although in the above description the controller 11 displays the list of the unread mails when the user flicks downward, the information to be displayed is not limited to the unread mails.

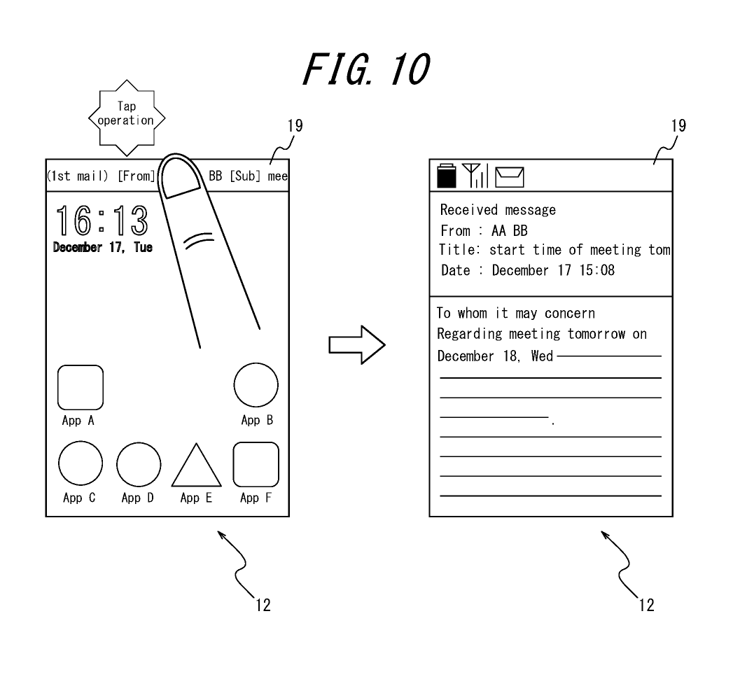

Next, an operation of the mail information display unit 19 to display the contents of the unread mail will be described. FIG. 10 is a diagram illustrating an example to display the contents of the unread mail by using the electronic apparatus 10. It is assumed here that the electronic apparatus 10 is the smartphone and the input unit 13 is the touch panel disposed on the front surface of the display unit 12.

As illustrated in FIG. 10, it is assumed that the user performs the tap operation at the portion of the touch panel corresponding to the mail information display unit 19 while the mail information is once again displayed. FIG. 10 illustrates an example in which the user performs the tap operation while the mail information of the first mail is displayed. The controller 11, based on the user's input operation via the input unit 13, controls the display unit 12 to display the contents of the mail (the first mail in FIG. 10) that is displayed in the mail information display unit 19 at the time of the tap operation. The user, by viewing the display of the display unit 12, may read the contents of the mail. In this way, since the contents of the mail are displayed in the display unit 12 in response to the user's tap operation, the user may quickly access the unread mail the user desires and view the contents thereof.

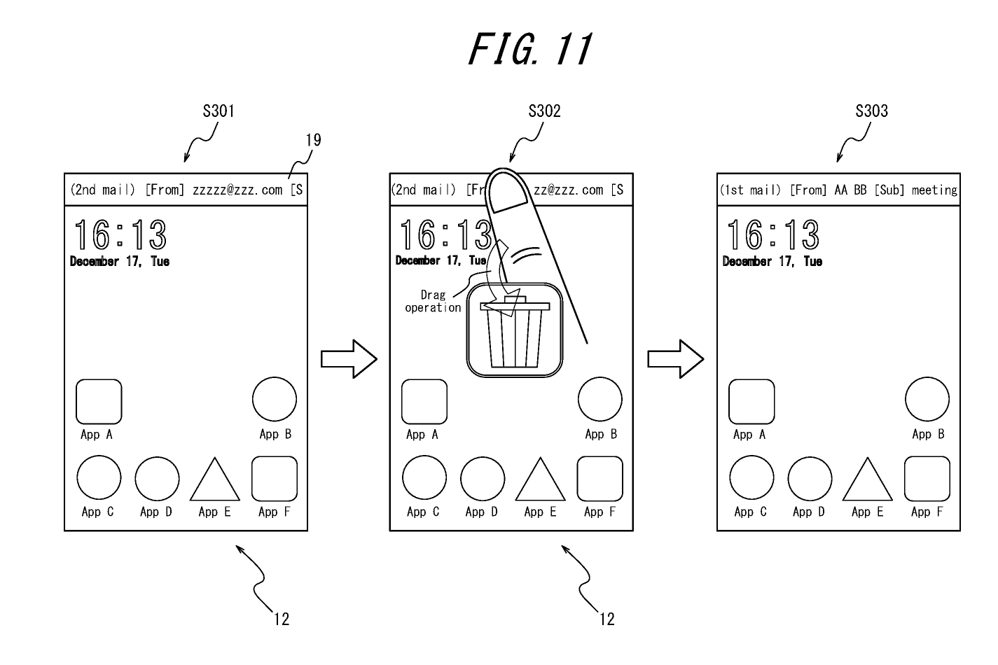

Next, an operation of the mail information display unit 19 to remove the unread mail will be described. FIG. 11 is a diagram illustrating an example to remove the unread mail by using the electronic apparatus 10. It is assumed here that the electronic apparatus 10 is the smartphone and the input unit 13 is the touch panel disposed on the front surface of the display unit 12, as well as that three unread mails are stored in the storage unit 15. At this time, the storage unit 15 has a list of unread mails to be displayed once again, and the list includes three unread mails. Here, also, assuming that the user wishes to remove the second unread mail from the three unread mails, a method to remove the second unread mail will be described.

The controller 11 sequentially displays the tree mails in the mail information display unit 19 of the display unit 12 (step S301). The user touches the portion of the touch panel corresponding to the mail information display unit 19 while the mail information of the mail the user wishes to remove is displayed. In response to that, the controller 11 displays, for example, an icon depicting a trash can for removal in the display unit 12 (step S302). When the user drags the mail information from the portion corresponding to the mail information display unit 19 where the user has been touching to the icon of the trash can, the controller 11, in response to this operation, removes the mail of the mail information being dragged (here, the second mail). Here, such a drag operation is a user's operation to touch the touch panel with the finger, move the finger without releasing the finger from the touch panel, and then release the finger when the finger reaches an intended area of the display unit 12. After the removal of the mail from the list, the controller 11 may display, for example, the mail information of the next mail (i.e., the first mail) as illustrated in FIG. 11 (step S303), or the mail information from the beginning (i.e., from the third mail) The controller 11, in the notification thereafter, omits the mail removed from the list based on the user's drag operation. In this way, the user may prevent unnecessary mail information from being displayed and efficiently view necessary mail information. This operation is effective when, for example, the user receives a mail sent to the user by mistake or an unwanted advertisement mail.

Note that, although in the above description the controller 11 removes the dragged mail from the list of the unread mails, the mail still remains in the list of received mails. Therefore, the user may view the mail removed from the list of the unread mails by accessing the mail in the inbox.

Also, the controller 11 may remove the dragged mail from the storage unit 15. Unlike the example described above, this case eliminates a user's operation to remove the unwanted mail from the inbox. However, the mail once being dragged is removed from the storage unit 15 and can no longer be displayed. As such, in order to prevent a user's misoperation, the controller 11, when the mail is dragged, may display a confirmation panel asking “Remove this mail?”, for example, in the display unit 12 to allow the user to select “Yes” or “No”. When the user selects “Yes”, the controller 11 may remove the mail of the interest, thereby preventing removal of the mail by mistake. Although in the above description the mail is removed by the drag operation, the operation to remove the mail is not limited thereto. For example, the controller 11 may remove the mail when the user flicks upward at the portion of the touch panel corresponding to the mail information display unit 19.

### Second Embodiment

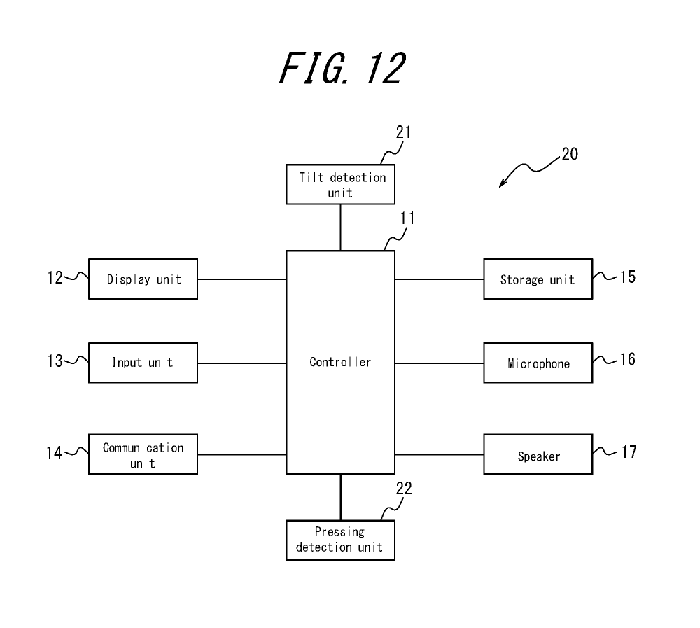

Next, a second embodiment of the disclosure herein will be described. FIG. 12 is a block diagram illustrating a schematic configuration of an electronic apparatus 20 according to the second embodiment. The electronic apparatus 20 of the second embodiment further includes a pressing detection unit 22 in addition to the electronic apparatus 10 of the first embodiment. Other than that, the configuration of the electronic apparatus 20 is the same as the electronic apparatus 10 of the first embodiment, and the same reference numbers are given to omit descriptions thereof.

The pressing detection unit 22 detects pressing caused by the user operating the input unit 13 and outputs data based on the pressing to the controller 11. The pressing detection unit 22 is constituted by using, for example, a strain gauge sensor, a piezoelectric element, or the like which changes physical or electrical property thereof (strain, resistance, a voltage, etc.) based on the pressing. When the pressing detection unit 22 is constituted by using, for example, the piezoelectric element, the piezoelectric element of the pressing detection unit 22, based on a magnitude of a load (force) of the pressing to the input unit 13 (or based on a changing speed (acceleration) of the magnitude of the load), changes a voltage value (data based on the pressing) indicative of the electric property. Note that the data based on the pressing may be, in lieu of the voltage value, the magnitude of the load of the pressing, a power value, a resistance value, and the like.

The controller 11 acquires the data based on the pressing to the input unit 13 from the pressing detection unit 22. Then, the controller 11, when the data based on the pressing is equal to or higher than a predetermined threshold, determines that a predetermined operation is carried out and, in accordance with the operation and based on application, for example, controls such that a predetermined operation is carried out.

The pressing detection unit 22 may be constituted based on a contact detection scheme. For example, when the contact detection scheme employed is of a resistance film type, a magnitude of the resistance in accordance with size of a contact area is associated with the load of pressing applied to a touch surface of the touch sensor. Thereby, the pressing detection unit 22 may be constituted without using the strain gauge sensor or the piezoelectric element. When the touch sensor is of a capacitive type, size of the capacitance is associated with the load of the pressing applied to the touch sensor. Thereby, the pressing detection unit 22 may be constituted without using the strain gauge sensor or the piezoelectric element.

In the electronic apparatus 20 of the second embodiment, the controller 11, for the flick operation in FIGS. 8A and 8B, for example, may use the data based on the pressing to the input unit 13 acquired from the pressing detection unit 22. That is, the controller 11, when the data acquired from the pressing detection unit 22 satisfies the predetermined threshold, may detect the operation of the input unit 13 as the flick operation.

As described above, the electronic apparatus 20 of the second embodiment further includes the pressing detection unit 22. Therefore, the electronic apparatus 20 may prevent itself from determining a light contact with another object as a user operation. Especially when the electronic apparatus 20 is held, the user's finger contacts the input unit 13. However, since the pressing detection unit 22 detects the pressing, incorrect determination to consider a user's unintentional touch as the user operation may be prevented.

Although the disclosure herein has been described based on the figures and the embodiments, it is to be appreciated that various modifications and changes may be implemented based on the present disclosure by those who are ordinarily skilled in the art. Accordingly, such modifications and changes are included in the scope of the disclosure herein.

For example, although in the description with reference to FIGS. 8A to 11 set forth above the electronic apparatus 10 is the smartphone and the input unit 13 is the touch panel disposed on the front surface of the display unit 12, the electronic apparatus 10 is not limited to the smartphone. Each operation in FIGS. 8A to 11 may be achieved by the feature phone having, for example, the operation button as the input unit 13. Further, the electronic apparatus 10 may be any other electronic apparatus including a tablet computer and the like.

Also, although in each of the descriptions with reference to FIGS. 8A to 11 set forth above an optimum operation for each processing is described by way of example, each of the operations are not limited thereto. For example, although in the description with reference to FIGS. 8A and 8B the user performs the flick operation, any other operation such as the tap operation may be performed. The same applies to the operations in the descriptions with reference to FIGS. 9 to 11.

Further, although in each description with reference to FIGS. 7A to 11 set forth above the controller 11 controls the display of the display unit 12 based on the input from the input unit 13, the input is not limited to one from the input unit 13. The controller 11 may control the display of the display unit 12 based on an input from the microphone 16 or the tilt detection unit 21. The input from the microphone 16 is, for example, a user's speech, and the controller 11 analyzes the speech input from the microphone 16 and, based on a result of the analysis, displays the mail information. For example, when the user says “Second mail”, the controller 11 may analyze the user's speech input from the microphone 16 and, as a result, display the mail information of the second mail from a plurality of mail information.

Also, the input from the tilt detection unit 21 is vibration or a tilt given to the electronic apparatus 10 by the user, and the controller 11 may control the display of the display unit 12 based on a result of the input from the tilt detection unit 21. For example, when the tilt detection unit 21 detects vibration at a predetermined threshold or higher, the controller 11 may update the display of the mail information. Also, for example, the controller 11, based on the tilt of the electronic apparatus 10 detected by the tilt detection unit 21, may control the display of the mail information.

Here, the display of the mail information based on an angle of the tilt will be specifically described with reference to FIGS. 8A and 8B as an example. Although in the description with reference to FIGS. 8A and 8B set forth above the controller 11 updates the display in response to the user's flick operation, the controller 11 may update the display based on the tilt of the electronic apparatus 10 detected by the tilt detection unit 21. For example, when the user tilts the electronic apparatus 10 to the left and the tilt detection unit 21 detects that the angle of the tilt of the electronic apparatus 10 exceeds a predetermined angle, the controller 11, similarly to the control in response to the flick operation to the left as described above, updates the display and displays the mail information next to the mail information being displayed. On the other hand, when the user tilts the electronic apparatus 10 to the right and the tilt detection unit 21 detects that the angle of the tilt of the electronic apparatus 10 exceeds a predetermined angle, the controller 11, similarly to the control in response to the flick operation to the right as described above, updates the display and displays previous mail information of the mail information being displayed.

Further, the controller 11, in accordance with the tilt detected by the tilt detection unit 21, may change a scroll speed of the mail information displayed in the mail information display unit 19. Specifically, as the user tilts the electronic apparatus 10 to the left further and further, the controller 11 may speed up the scroll speed of the mail information and, as the user tilts the electronic apparatus 10 to the right further and further, the controller 11 may slow down the scroll speed of the mail information. In this way, the user may view the mail information by easily changing the scroll speed based on the contents and importance of the mail information. Note that, although the electronic apparatus 10 is tilted to the left or right here, a direction to tilt the electronic apparatus 10 is not limited thereto but may be in any direction including, for example, forward and backward.

Also, the controller 11, before or after displaying the mail information, may display any other information in the display unit 12. For example, the controller 11, before displaying the mail information, may display current time for a predetermined period of time (e.g. 2 seconds). After finishing displaying the current time, the controller 11 may display the mail information. At this time, when the user performs a predetermined operation by using the input unit 13 while the other information such as the current time is displayed, the controller 11 may display the mail information before the predetermined period of time for displaying the other information elapses. Alternatively, the controller 11 may simultaneously display the mail information and the other information in the display unit 12. In this case, the mail information and the other information are displayed in two rows in a vertical direction, for example. This allows the user to view the other information preferentially over, or simultaneously with, the mail information.

Also, the controller 11 may preferentially display the mail information of a more important mail. The more important mail may be, for example, a mail sent from a predetermined sender the user has preliminarily registered with the storage unit 15 by using the input unit 13, a mail containing a predetermined character string, a mail sent in a predetermined period of time, and the like. The controller 11, when displaying the mail information, may first display the mail information of the more important mail followed by the mail information of another mail in the display unit 12. Also, the controller 11, instead of preferentially displaying the mail information of the more important mail, may render the mail information of the more important mail stand out. This may be performed in any manner including, for example, changing color of characters of the mail information or color of the mail information display unit 19, increasing font size of the characters, changing an image displayed in the display unit 12, and the like. Also, the controller 11 may render the mail information of the more important mail stand out by generating a sound from the speaker 17 or by vibrating the electronic apparatus 10. Thereby, the user is more likely to pay attention on the mail information of the more important mail.

Also, the controller 11 may display the mail information in the display unit 12 by excluding predetermined information. The predetermined information may be any information the user has preliminarily registered with the storage unit 15 by using the input unit 13 such as, for example, the predetermined sender and a predetermined character string. For example, when the user sets such that the mail information does not include the predetermined sender, the controller 11 displays the mail information without displaying the predetermined sender. At this time, based on user setting, the controller 11 may display a substitute character string that has been preliminarily registered. For example, when the user sets such that the mail information displays “sender A” in lieu of information on the sender “AA BB”, the controller 11 displays the mail information displaying the sender as the “sender A” in lieu of the “AA BB” in the display unit 12. Thereby, information the user does not wish to be revealed to a third party is prevented from being displayed in the display unit 12. Accordingly, even when the mail information is displayed in, for example, the locked screen, such information may be prevented from being revealed to a third party.

Also, for example, in a case where the display unit 12 is a display constituted by using a self-luminous element (the organic EL display), when the screen of the display unit 12 is off, the controller 11 may display the mail information by turning on the screen of the mail information display unit 19 alone. That is, the mail information may be displayed in the screen of the mail information display unit 19 while other screens remain off (while the power saving screen is displayed). Limiting an area of the screen to be turned on in this manner may reduce the power consumption of the electronic apparatus 10.

Further, although in the above embodiments the controller 11 displays the mail information in the display unit 12, an output method of the mail information is not limited thereto. For example, the controller 11 may output a speech reading the mail information from the speaker 17. Also, although in the above embodiments the display of the mail information is described, an item to be displayed is not limited to the mail information but may be, for example, information associated with a schedule input to the electronic apparatus 10.

### REFERENCE SIGNS LIST

10, 20 electronic apparatus
11 controller
12 display unit
13 input unit
14 communication unit
15 storage unit
16 microphone
17 speaker
18 housing
19 mail information display unit
21 tilt detection unit
22 pressing detection unit

1. An electronic apparatus having a controller for providing a notification of, upon reception of a mail, mail information containing a portion of contents of the mail in a display unit, wherein
the controller, when a screen of the display unit changes from an off-state to an on-state, provides a re-notification of the mail information of an unread mail in the display unit and, based on an input operation via an input unit during the re-notification, displays the mail information in the display unit.

2. The electronic apparatus according to claim 1, wherein
the input unit is constituted by using operation buttons, and
the controller, based on the pressing of a predetermined button of the operation buttons, updates the mail information and displays updated mail information in the display unit.

3. The electronic apparatus according to claim 1, wherein
the input unit is constituted by using a touch panel disposed on a front surface of the display unit, and
the controller, based on an operation to the touch panel at a position corresponding to a display position of the mail information, updates the mail information and displays updated mail information in the display unit.

4. The electronic apparatus according to claim 1, wherein
the input unit is constituted by using a touch panel disposed on a front surface of the display unit, and
the controller, based on an operation to the touch panel at a position corresponding to a display position of the mail information, displays a list of unread mails in the display unit.

5. The electronic apparatus according to claim 1, wherein
the input unit is constituted by using a touch panel disposed on a front surface of the display unit, and
the controller, based on an operation to the touch panel at a position corresponding to a display position of the mail information, displays contents of the unread mail in the display unit.

6. An electronic apparatus having a controller for providing a notification of, upon reception of a mail, mail information containing a portion of contents of the mail in a display unit, wherein
the controller, when a screen of the display unit changes from an off-state to an on-state, provides a re-notification of the mail information of an unread mail in the display unit and, based on an input operation via an input unit during the re-notification, refrains from providing the re-notification of the mail information after the input operation.

7. The electronic apparatus according to claim 6, wherein
the controller, based on the input operation, removes the unread mail associated with the mail information from a storage unit storing the unread mail.

8. An electronic apparatus having a controller for providing a notification of, upon reception of a mail, mail information containing a portion of contents of the mail in a display unit, wherein
the controller, when a screen of the display unit changes from an off-state to an on-state, provides a re-notification of the mail information of an unread mail in the display unit and, based on a tilt of the electronic apparatus detected by a tilt detection unit during the re-notification, displays the mail information in the display unit.

9. An information display method of an electronic apparatus having a controller for providing a notification of, upon reception of a mail, mail information containing a portion of contents of the mail in a display unit, the information display method comprising:
providing a re-notification of, when a screen of the display unit changes from an off-state to an on-state, the mail information of an unread mail in the display unit; and
displaying, based on an input operation via an input unit during the re-notification, the mail information in the display unit.

10. An information display method of an electronic apparatus having a controller for providing a notification of, upon reception of a mail, mail information containing a portion of contents of the mail in a display unit, the information display method comprising:
providing a re-notification of, when a screen of the display unit changes from an off-state to an on-state, the mail information of an unread mail in the display unit; and
refraining from, based on an input operation via an input unit during the re-notification, providing the re-notification of the mail information after the input operation.

11. An information display method of an electronic apparatus having a controller for providing a notification of, upon reception of a mail, mail information containing a portion of contents of the mail in a display unit, the information display method comprising:
providing a re-notification of, when a screen of the display unit changes from an off-state to an on-state, the mail information of an unread mail in the display unit; and
displaying, based on a tilt of the electronic apparatus detected by a tilt detection unit during the re-notification, the mail information in the display unit.
